(19) United States
(12) Patent Application Publication
(10) Pub. No.: US 2022/0274272 A1
(43) Pub. Date: Sep. 1, 2022

(54) Modular Electric Hair-Cutting Devices and Methods

(71) Applicant: Duett, LLC, Starkville, MS (US)

(72) Inventors: Tyler Albert Anthony, Starkville, MS (US); Thomas Gerard White, Starkville, MS (US); Wade Patterson, Huntsville, AL (US); Patrick Stapler, Huntsville, AL (US); Daniel Lipszyc, Las Vegas, NV (US)

(73) Assignee: Duett, LLC, Starkville, MS (US)

(21) Appl. No.: 17/697,855

(22) Filed: Mar. 17, 2022

Related U.S. Application Data
(63) Continuation-in-part of application No. 16/418,010, filed on May 21, 2019, now abandoned.

(51) Int. Cl. B26B 19/38; B26B 19/20

(52) U.S. Cl. CPC B26B 19/388; B26B 19/205

(57) ABSTRACT

An electric hair-cutting device that has a housing. Further, the electric hair-cutting device has a hair-cutting module coupled to a first end of the housing, the hair-cutting module comprising blades and configured for cutting hair. Also, the electric hair-cutting device has a plurality of pinholes on a top of the housing and adjacent the hair-cutting module for delivering air to the hair-cutting module to cool the hair-cutting blades and a cooling module contained in the housing, the cooling module that has a fan and receives air through a plurality of pinholes on a bottom end of the housing and delivers the air to the plurality of pinholes adjacent the hair-cutting module thereby cooling the hair-cutting module.

### CROSS REFERENCE TO RELATED APPLICATIONS

This Application claims priority to and is a Continuation-In-Part of U.S. patent Ser. No. 16/418,010 entitled Modular Electric Hair-Cutting Devices and Methods filed May 21, 2019, which is incorporated by reference in its entirety.

### BACKGROUND

Barbers often use electric hair-cutting devices when cutting an individual's hair. The electric hair-cutting devices typically have a cutting module that comprises a blade. In operation, the hair-cutting devices often heat up rapidly to high temperatures. This often causes the hair-cutting devices to overheat. In this regard, when the hair-cutting devices overheat the barber is unable to sustain all day use without the electric hair-cutting devices becoming excessively hot and overheating. Furthermore, when the hair-cutting devices are in continuous or frequent use, they often fail to sustain a comfortable operating temperature for its motor, enclosure, and consequently its internal components which overheat the device. Note that once the hair-cutting device overheats, the barber is forced to change to a different hair-cutting device.

There exist some solutions that attempt to mitigate blade overheating and keep temperatures within the hair-cutting device enclosure low. For example, some hair-cutting devices use heat-resistant materials for its enclosure. However, these solutions fail to sustain the continuous and/or frequent use which the barber requires. While they do temporarily reduce the discomfort the operator experiences initially, as the device continues to operate its temperature continuously rises. This inevitably causes the device to overheat and forces its operator to switch to another device.

### BRIEF DESCRIPTION OF THE DRAWINGS

The system is described with reference to the accompanying drawings. In the drawings, like reference numbers indicate identical or functionally similar elements. Additionally, the left-most digit(s) of a reference number identifies the drawing in which the reference number first appears.

FIG. 1 is a perspective view of an exemplary modular hair-cutting device in accordance with an embodiment of the present disclosure.

FIG. 2 is a cross-sectional plan view of the modular hair-cutting device shown in FIG. 1.

FIG. 3 is a cross-sectional perspective view of the modular hair-cutting device shown in FIG. 1.

FIG. 4 is a block diagram of an exemplary controller of the modular hair-cutting device shown in FIG. 1.

FIG. 5 is a flowchart of exemplary architecture and functionality of the hair-cutting device shown in FIG. 1.

FIG. 6 is perspective view of another embodiment of the modular hair-cutting device shown in FIG. 1 with the blade head removed.

FIG. 7 is a cut-away perspective view of the modular hair-cutting device shown in FIG. 6 with the blade head removed.

FIG. 8 is a cut-away perspective view of the modular hair-cutting device shown in FIG. 6 with the blade head attached.

### DETAILED DESCRIPTION

The electric hair-cutting and/or fur-cutting device of the present disclosure at a barber's workstation barber and/or their clients do not feel the discomfort as an electric hair-cutting device overheats. In one embodiment, the electric hair-cutting device is modular taking both the form and function of whichever device the barber requires. For example, a head of the hair-cutting device has an interchangeable head so that the hair-cutting device my serve as a clipper, a trimmer, or shaver during the course of cutting a client's hair. In one embodiment the electric hair-cutting device does not have to be modular. In such an embodiment, the electric hair-cutting device is module. That is the head may be removeable from the body so that other different heads may be used.

Additionally, the electric hair-cutting device comprises an autonomous temperature control, which maintains the optimal operating temperature to sustain all day and/or extended use and protect the components of the device. In one embodiment, the hair-cutting device has one motor dedicated to the blade assembly for cutting and a second motor for controlling a cooling device. In the embodiment, the hair-cuter device autonomously controls an internal fan for temperature regulation purposes while the cutting elements are not in use. Therefore, the hair-cutting device of the present disclosure provides a single electric hair-cutting device capable of functioning as a clipper, a trimmer, or a shaver and autonomously maintains a predetermined temperature while its cutting elements are active and/or inactive.

The hair-cutting device of the present disclosure is made up of the following components: cutting module power switch, cooling module power switch, temperature control feedback circuit, cutting module motor and blade driving piece, cooling module motor, temperature and or humidity sensor(s), module enclosure(s) which may or may not have attachable/detachable elements, cutting blade, still blade, cutting blade drive assembly, cooling module fan.

The cutting module comprises a cutting blade, still blade, and motor at the front-end termination. The cutting module is securely attached to an autonomous cooling module which drives a second motor equipped with a fan mounted to its rotor that autonomously circulates ambient air about and around the system in response to temperature sensor readings which exceed the predetermined temperature range within the device.

In one embodiment, the hair-cutting device may comprise a second fan mounted on the rotor of the cutting module's motor. In another embodiment, the hair-cutting device may comprise ventilation slits on the autonomous cooling module and/or cutting module's enclosure(s), contoured hand grips on the autonomous cooling module and or cutting module, attachable/detachable hair-cutting module to function as clipper, trimmer, or shaver, a detachment/reattachment system for the rapid interchangeability of the device or system, and a swivel cord to prevent cord bending and/or component damage.

Note that while the modular hair-cutting device may be used on human hair; however, the modular hair-cutting device may also be used on fur, such as animal fur.

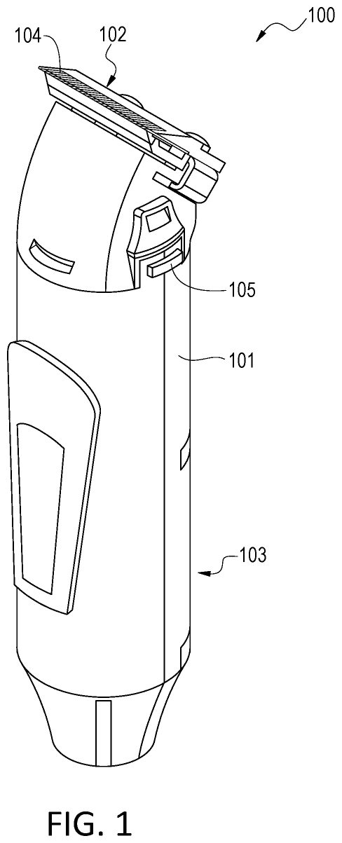

FIG. 1 is a perspective view of a hair-cutting device 100 in accordance with an embodiment of the present disclosure. The hair-cutting device 100 comprises a housing 103. The hair-cutting device 100 comprises a gripper portion 101 that a barber grasps while the hair-cutting device 100 is in use. Note that portions of the gripper portion 101 may be contoured for easier grasping.

The hair-cutting device 100 is electric. Thus, the hair-cutting device 100 comprises a power cord (now shown) that extends from a housing 103 of the hair-cutting device 100 to a wall power receptacle. In one embodiment, the cord may be a swivel cord that prevents the cord from bending and/or causing component damage.

The hair-cutting device 100 comprises a cutting head 102. The cutting head 102 comprises at least a blade assembly 104 for cutting a client's hair. The cutting head 102 also comprises a latch mechanism 105 so that the cutting head 102 may be removed from the handle 101. Once removed, a clipper head (not shown), a trimmer head (not shown), or a shaver head (not shown) may replace the cutter head 102. This enables more versatile use of the hair-cutting device 100.

Note that on the outside surface of the handle 101 there may be power a power switch. When activated,

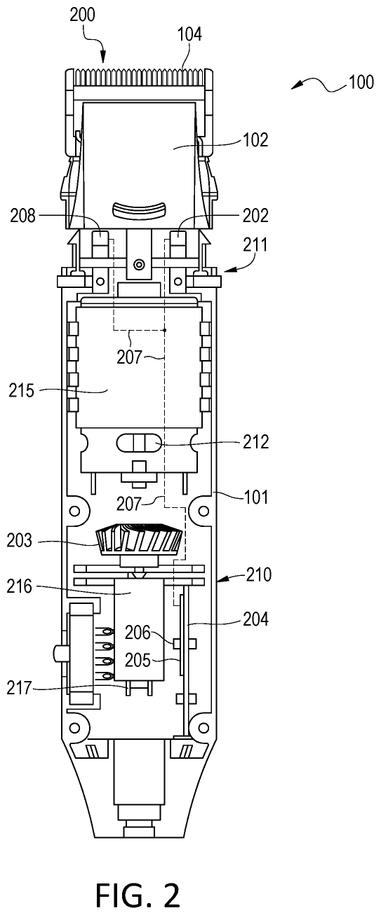

FIG. 2 is a cross-sectional view of the hair-cutting device 100 where the cutting head 102 has been removed from the handle 101 of the hair-cutting device 100. This is shown in this manner to expose temperature sensors 202 and 208, which are described further herein. Note that in one embodiment, the sensors 202 and 208 detect humidity.

The hair-cutting device 100 comprises a hair-cutting module 211 and an autonomous cooling module 210. The hair-cutting module 211 comprises a switch 212 on the housing 103 (FIG. 1), as described hereinabove. The switch 212 activates the hair-cutting module 211.

The switch 212 activates a rotary motor 215 of the hair-cutting module 211. The motor 215 drives the cutting blade assembly 104 or any other type of head attached to the handle 101 when the switch 212 is activated.

Coupled in the hair-cutting module 211 is a plurality of temperature sensors. In the embodiment shown, the hair-cutting device 100 comprises two temperature sensors 202 and 208. The sensors 202 and 208 are electrically coupled to a printed circuit board (PCB) 104 in the autonomous cooling module 210 via electrical connections 207, e.g., wires. Operation is described further herein. The temperature sensors 202 and 208 sense the temperature of the hair-cutting module 211 and transmit data indicative of the temperature sensed to the PCB 204.

Note that in one embodiment, the hair-cutting module 211 may comprise a fan (not shown). This fan may be coupled to the rotor of the motor 215. The fan can be activated based upon temperature readings from the sensors 202 and 208.

The autonomous cooling module 210 comprises a fan 203. The fan 203 is activated and driven by a motor 216. When the fan 203 is active is has a cooling effect on the internal components of the hair-cutting device 100.

Further, the autonomous cooling module 210 comprises the PCB 204. Coupled to the PCB 204 is a temperature sensor 206 and a microcontroller 205. The temperature sensor 206 is configured to sense the temperature of the autonomous cooling module 210.

In operation, a barber switches on the hair-cutting module 211. The barber begins to cut a client's hair. While the blade assembly 104 is cutting the client's hair, the temperature sensors 202 and 208 are continuously or at a predetermined interval sampling the temperature of the cutting module 211. Data indicative of the temperatures sensed are transmitted to the microcontroller 205 of the PCB 104 of the autonomous cooling module 210. Simultaneously therewith, the temperature sensor 206 is transmitting data indicative of the temperature of the autonomous cooling module 210 to the microcontroller 205.

The microcontroller 205 compares the data received indicative of the temperatures from the sensors 202 and 208 in the cutting module 211 with a threshold temperature. If the data indicative of the temperatures is greater than the threshold temperature, the microcontroller 205 transmits a signal to the motor 216 activating the fan 203. Also, the microcontroller 205 compares the data indicative of the temperature from the sensor 206 with a threshold temperature. If the data indicative of the temperature is greater than a threshold temperature, the microcontroller 205 transmits a signal to the motor 216 activating the fan 203.

While the fan is continuously cooling down the internal components of the hair-cutting device 100, the microcontroller 205 continues to sample the temperatures from the sensors 202, 208, and 204. The microcontroller 205 compares the data indicative of the temperatures sensed to the threshold temperature. If the data indicative of the temperatures sensed is less than the threshold temperature, the microcontroller 205 transmits a signal to the motor 216 to deactivate the fan 203.

Note that in one embodiment, the housing 103 may comprise ventilation slits (not shown). The ventilation slits may be configured in the hair-cutting module 211 or the cooling module 210. The ventilation slits would allow warm/hot air to escape the housing 103 to further keep the temperature of the hair-cutting device low.

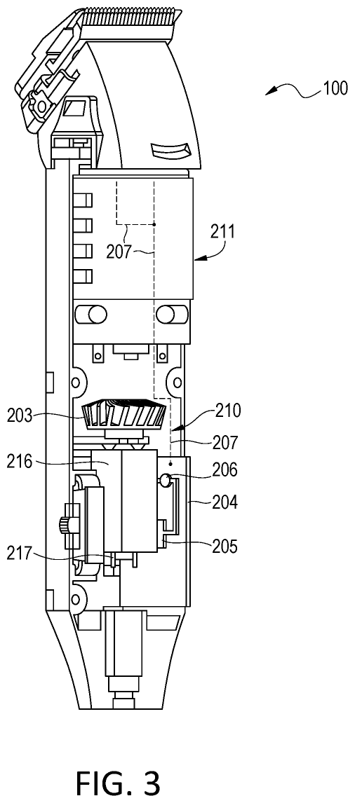

FIG. 3 is a perspective view of the hair-cutting device 100 showing the printed circuit board (PCB) 204, the microcontroller 205 and the temperature sensor 206. The temperature sensor 206 measures the temperature in the autonomous cooling module 210 and transmits data indicative of the temperature sensed to the microcontroller 205.

Further, the sensors 202 and 208 in the cutting module 211 also sense temperature and transmit data indicative of the temperature sensed to the microcontroller 205 on the PCB 204.

Based on the temperatures detected, the microcontroller 205 controls the motor 216 of the fan 203. In this regard, if the temperatures detected are above a threshold, the microcontroller 205 transmits a signal to the motor 216 of the fan 203 activating the fan 203. If the temperatures detected are below the threshold, the microcontroller 205 transmits a signal to the motor 201 of the fan 203 to deactivate the fan 203 if the fan 203 is on.

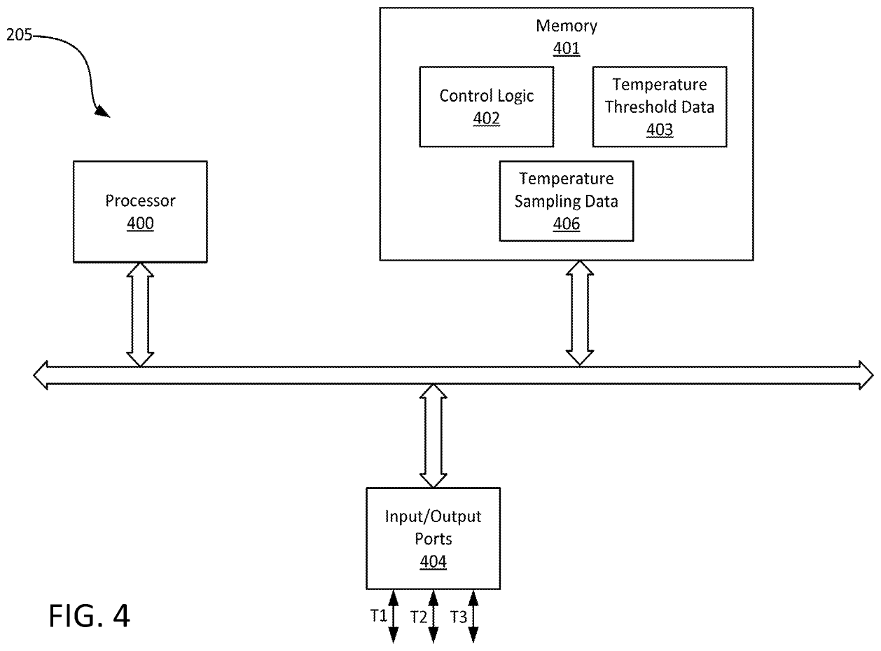

FIG. 4 is a block diagram of an exemplary microcontroller 205 in accordance with an embodiment of the present disclosure. The microcontroller 205 comprises a processor 400, input/output ports 404, and memory 401. Each of these components communicates over local interface 405, which can include one or more buses.

The microcontroller 205 further comprises control logic 402. Control logic 402 can be software, hardware, or a combination thereof. In the exemplary microcontroller 205 shown in FIG. 4, control logic 402 is shown as software stored in memory 401. Memory 401 may be of any type of memory known in the art, including, but not limited to random access memory (RAM), read-only memory (ROM), flash memory, and the like.

When stored in memory 401, control logic 402 can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions.

In the context of the present disclosure, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium

The microcontroller 205 further comprises temperature threshold data 403 and temperature sampling data 406. The threshold data 403 contains data indicative of temperatures at or above which the cooling module 210 (FIG. 2) activates to cool the hair-cutting device 100. Further, the temperature sampling data 406 comprises data indicative of the temperatures identified by the data received from the sensors 202 (FIG. 2), 208 (FIG. 2), and 206 (FIG. 2).

Processor 400 may be a digital processor or other type of circuitry configured to run the control logic 402 by processing and executing the instructions of the control logic 402. By way of example, the processor 400 may be an 8-bit, a 16-bit, or a 32-bit processor.

The input/output ports 404 are configured for receiving and transmitting data via lines T1, T2, and T3. In this regard, the sensors 202, 208, and 204 transfer data indicative of temperature samples, and this data is received via the lines T1, T2, and T3 by the input/output ports 404. The control logic 402 stores the data indicative of the temperatures as temperature sampling data 406.

In operation, the hair-cutting device 100 is switched on via switch 212. Once activated, a barber begins cutting a client's hair with the blade 104. During operation of the hair-cutting module 211, the temperature sensors 202 and 208 continuously or periodically sample the temperature of the hair-cutting module 211. Data indicative of the sampled temperatures is transmitted to the microcontroller 205 (FIG. 2) via the electrical lines 207. Notably, the temperatures sensor 206 also continuously or periodically samples the temperature of the cooling module 210. Data indicative of the sampled temperature is transmitted to the microcontroller 205.

Upon receipt of data indicative of the temperatures, the control logic 402 stores the received data as temperature sampling data 406. Further, the control logic 402 compares the data indicative of the temperatures received to the temperature threshold data 403.

If during operation the comparison indicates that the internal components are at a temperature above the temperature threshold data 403, the control logic activates the motor 216, which activates the fan 203. The fan 203 rotates and circulates air throughout the housing 103.

While the fan 203 is rotating, the microcontroller 205 continues to receive data from sensors 202, 208, and 206 indicative of the temperature of the cutting module 211 and the cooling module 210. Further, the microcontroller 205 continues to compare the data indicative of the temperatures received to the temperature threshold data 403.

If the comparison indicates that the temperature in the housing 103 is below the temperature threshold data 403, the microcontroller 205 deactivates the motor 216, which deactivates the fan 203. The microcontroller 205 continues to make comparisons of the data indicative of the temperatures received, and the microcontroller 205 activates and deactivates the motor 216 and the fan 203 accordingly to keep the temperature within the housing 103 at an acceptable level, i.e., a level at which the blades do not overheat or the cutting module does not overheat.

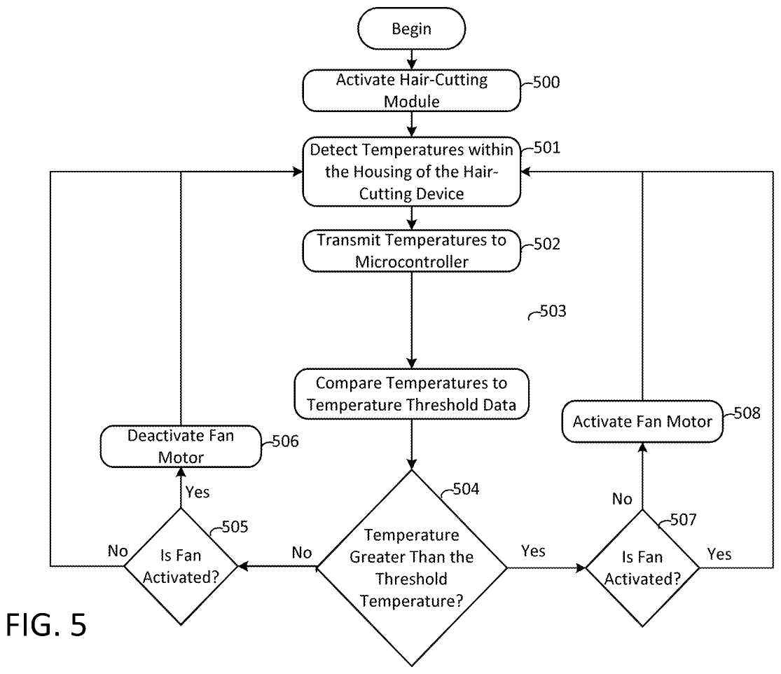

FIG. 5 is a flowchart depicting exemplary functionality of the hair-cutting device 100. In this regard, a barber activates the hair-cutting module 211 (FIG. 2) in step 500. The hair-cutting module 211 may be activated by a switch 212 (FIG. 2). The switch 212 may be on the outer surface of the housing 103 (FIG. 1).

Once the hair-cutting module 211 is activated, the hair-cutting device 100 detects temperatures within the housing 103 of the hair-cutting device in step 501. As described hereinabove, sensors 202 (FIG. 2) and 208 (FIG. 2) detect temperatures of the hair-cutting module 211. The sensor 206 detect the temperature of the cooling module 210 (FIG. 2).

In step 502, the sensors 202, 208, and 206 transmit data indicative of the temperatures detected to the microcontroller 205 (FIG. 5). Note that the sensors 202 and 208 detect temperatures in the cutting module 211, while the sensor 206 detects the temperature in the cooling module 210.

Upon receipt of the data indicative of the temperatures, the microcontroller 205 compares the data indicative of the temperatures received to the temperature threshold data 403 (FIG. 4) in step 503. If the temperature is greater than the threshold temperature in step 504, the microcontroller 205 increases the speed of the fan 203 (FIG. 2.

If the temperature is not greater than the threshold temperature in step 504, the microcontroller 205 decreases the speed of the fan 203 The process begins again at step 501.

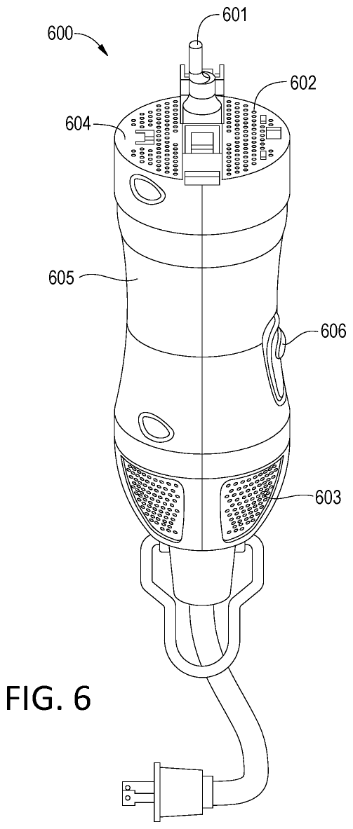

FIG. 6 is a modular hair-cutting device 600 with the blade head removed to show features of the device. There is a connection point 601 that receives and couples to the blade head (not shown) and connects the blade head to a body 605.

The modular hair-cutting device 600 comprises a flat, circular surface 604 at the top of the body 605. The flat circular surface 604 is adjacent the blade head when the blade head is affixed to the connection point 601. The circular surface 604 comprises a plurality of pinholes 602. In use, the modular hair-cutting device 600 transmits air up through the plurality of pinholes 602, and the air cools the blade head.

At the electrical connector end of the body 605 is a plurality of rounded, trapezoidal-shaped surfaces 603. There is a plurality of pinholes 603 in the plurality of rounded, trapezoidal-shaped surfaces 603 laterally disposed on the bottom of the body 605.

In operation, a fan (not shown) contained in the body 605 of the modular hair-cutting device 600 pulls air into the modular hair-cutting device 600 through the plurality of pinholes 603 in the plurality of rounded, trapezoidal-shaped surfaces 603 laterally disposed on the bottom of the body 605.

The fan creates positive pressure such that the air pulled into the modular hair-cutting device from pinholes 603 is dispersed upwardly. The air travels upward and out of the plurality pinholes 602 on the surface 604. The air that travels out through the pinholes 602 strikes the blade head (not shown) and cools the blades (not shown).

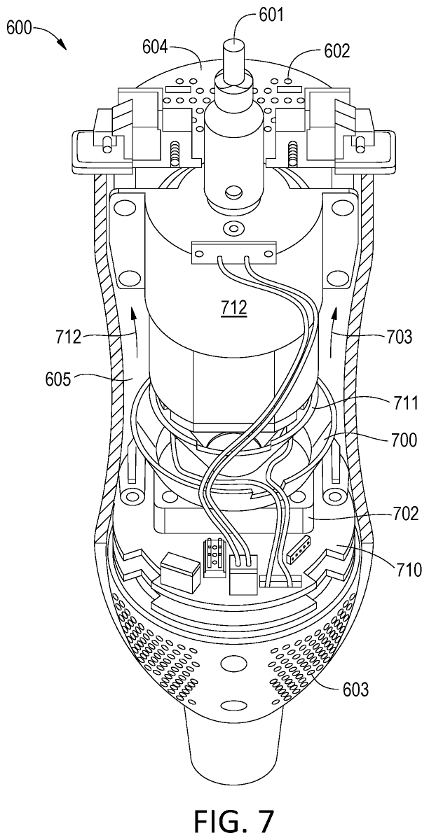

FIG. 7 is a cut-away view of the modular hair-cutting device 600. At the top of the modular hair-cutting device is a connector 601 for connecting to a blade head (not shown). The circular surface 604 comprises the plurality of the pinholes 602 through which air travels. As air travels through the pinholes 602, the blades (not shown) in the blade head (not shown) are cooled.

At the bottom of the modular hair-cutting device is a plurality of pinholes 603. Air is pulled through the plurality of pinholes 603 via the fan 702. The fan 702 disperses the air so that the air travels throughout the body 605 and up the sides of the motor 712, as shown by reference arrows 712 and 703.

The modular hair-cutting device further comprises a motor 712. The motor 712 drives the blades in the blade head.

The modular hair-cutting device 600 further comprises a fan 702, which has a motor included in the fan housing. The fan 702 pushes air upward and between the circular air plenums 700 and 711. Note that the air plenum 700 has a larger diameter than the air plenum 711. Thus, air escapes between the plenums 700 and 711 and up into the body 605 of the modular hair-cutting device 600 as shown by reference arrows 703 and 702.

The modular hair-cutting device further comprises sensors. There is a sensor located at the top the body 605 and a sensor located underneath a microprocessor board 710. In operation, the fan 702 is activated when the blade head 800 is activated. Thus, there is a constant flow of air upwards through the body 605.

As the fan 700 operates, the fan 700 pulls air into the body 605 of the hair-cutting module 605 creating positive pressure. The air travels upward within the body 605 along arrows 712 and 703. The air is delivered to the pinholes 602 on the surface 604. The air traveling through the pinholes 602 cools the blade head (not shown) coupled to the connector 601.

Further, the modular hair-cutting device 600 comprises the motor 712. The motor 712 powers the blades in the blade head. In operation, the fan 702 pushes air along reference lines 703 and 704 to the pinholes 602. In addition, simultaneously, the fan 702 also cools the motor 712. Furthermore, the positive pressure created by the fan 702 ensures that hair and/or fur does not breach the body 605.

If the sensor 716(not shown) at the top of the body 605 detects a temperature above a threshold temperature, the microcontroller increases the speed of the fan 702 to cool the blade head and the blades. Also, if the sensor (not shown) on the microcontroller 710 senses a temperature above a threshold temperature, the microcontroller can increase the speed of the fan to cool down the cooling system. On the contrary, if the sensor at the top of the body 605 detects a temperature below the threshold temperature, the microcontroller 710 can decrease the speed of the fan 702. If the sensor coupled on the bottom of the microcontroller detects a temperature that is below the threshold temperature, the microcontroller 710 can decrease the speed of the fan 702.

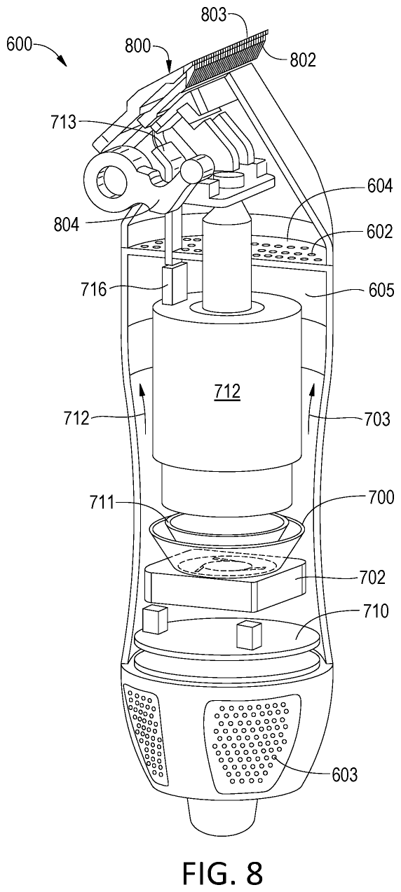

FIG. 8 is a cut-away view of the modular hair-cutting device 600. The modular hair-cutting device 600 comprises a blade head 800 that comprises a stationary blade 802 and a moveable blade 803. Separation of the blades is adjustable by actuating the lever 804. This allows hair to be cut in varying lengths.

The modular hair-cutting device 600 further comprises temperature sensor 716. The temperature sensor 716 senses the temperature of the blade head 800 via a heat pipe 713 that extends from the blade head 800 to the sensor 716. The heat pipe 713 senses the temperature of the blades 802 and 803 when the blades 802 and 803 are based on a modular approach. Upon receipt, the microprocessor can extrapolate the temperature of the blades 802 and 803 using the temperature of the heat pipe 713.

Below the blade head 800 and at the top of the modular hair-cutting device body 605 is the plurality of pinholes 602 on the surface 604. Air is directed through the pinholes 603 when the fan 702 is active. The air is directed by the inner plenum 711 and the outer plenum 700 up the body 605 toward and out of the pinholes 602. The air that exits the pinholes 602 are directed to the blade head 800 and the blades 802 and 803. In addition, the fan 702 simultaneously cools the motor 712.

Further, at the bottom of the modular hair-cutting device are a plurality of pinholes 603 situated laterally on the bottom sides of the body 605. The fan 702 pulls in the air through the pinholes 603. The air is directed from the fan 702 out and between the plenums 700 and 711, which is then directed to the blade head 800 and the blades 802 and 803 as described hereinabove.

In operation, the fan 702 pulls air into the modular hair-cutting body 605 creating positive pressure. The fan 702 pushes the air upward along reference lines 703 and 704 with the nested plenums 700 and 711. The air travels through the pinholes 602 and cools the blade head 800 and the blade 803 and 802. The motor 712 is also cooled by the air. Furthermore, the positive pressure created by the fan 702 ensures that hair and/or fur does not breach the body 605.

What we claim is:

1. An electric hair-cutting device, comprising:
a housing;
a hair-cutting module coupled to a first end of the housing, the hair-cutting module comprising blades and configured for cutting hair and or fur;
a plurality of pinholes on a top of the housing and adjacent the hair-cutting module for delivering air to the hair-cutting module to cool hair-cutting blades; and
a cooling module contained in the housing, the cooling module comprising a fan and configured to receive air through a plurality of pinholes on a bottom end of the housing and deliver the air to the plurality of pinholes adjacent the haircutting module thereby cooling the hair-cutting module.

2. The electric hair-cutting device of claim 1, further comprises a motor for operating the hair-cutting module.

3. The electric hair-cutting device of claim 2, wherein the fan simultaneously cools the hair-cutting module and the motor.

4. The electric hair-cutting device of claim 1, wherein the fan creates positive pressure in a body of the modular electric hair-cutting device which prohibits hair from breaching the body.

5. The electric hair-cutting device of claim 1, wherein the hair-cutting module and the cooling module are modular.

6. The electric hair-cutting device of claim 1, wherein the hair-cutting module and the cooling module are integral.

7. The modular electric hair-cutting device 1, further comprising a processor configured for receiving data indicative of a temperature from the at least one sensor contained in the housing and comparing the temperature to a threshold temperature, the processor further configured to increase or decrease the fan speed depending upon a comparison of the data indicative of the temperature and the threshold temperature to cool the motor and/or an interior of the body.

8. The modular electric hair-cutting device of claim 1, wherein the hair-cutting module further comprises a second sensor for detecting temperature of the hair-cutting module.

9. The modular electric hair-cutting device of claim 3, wherein the processor is further configured to receive data indicative of a temperature from the second sensor.

10. The modular electric hair-cutting device of claim 5, wherein the processor is further configured to increase or decrease the speed of the fan if the depending upon a comparison of the data received indicative of temperature and a threshold temperature.

11. The electric hair-cutting device of claim 1, wherein the hair-cutting module of the hair-cutting device is removeable.

12. The electric hair-cutting device of claim 8, wherein the hair-cutting module is configured to be replaced by a clipper head.

13. The electric hair-cutting device of claim 8, wherein the hair-cutting module is configured to be replaced by a trimmer head.

14. The electric hair-cutting device of claim 8, wherein the hair-cutting module is configured to be replaced by a shaver head.

15. The electric hair-cutting device of claim 11, wherein the cooling module comprises a motor for driving the fan that cools the components in the housing when activated.

16. The electric hair-cutting device of claim 1, wherein the fan is configured to be active even if the hair-cutting module is not operating.

17. The electric hair-cutting device of claim 1, wherein an outer surface of the housing comprises contoured areas for easy grasping.

18. The electric hair-cutting device of claim 1, wherein a handle is coupled to a top blade of the hair-cutting module that when actuated increases the distance between the blades to vary hair length.

19. An electric hair-cutting method, comprising:
providing a housing;
cutting hair by a hair-cutting module coupled to a first end of the housing, the hair-cutting module comprising blades;
delivering air to a plurality of pinholes on a top of the housing and adjacent the hair-cutting module to cool the hair-cutting blades; and
receiving air through a plurality of pinholes on a bottom of the housing;
receive air via a fan through a plurality of pinholes on a bottom end of the housing; and
delivering the air to the plurality of pinholes adjacent the haircutting module thereby cooling the hair-cutting module.
